(19) United States
(12) Patent Application Publication
(10) Pub. No.: US 2014/0207565 A1
(43) Pub. Date: Jul. 24, 2014

(54) INCENTIVIZED MARKETING SYSTEM AND METHOD

(71) Applicant: Robert Jacobs, Franklin, NY (US)

(72) Inventor: Robert Jacobs, Franklin, NY (US)

(21) Appl. No.: 14/218,632

(22) Filed: Mar. 18, 2014

Related U.S. Application Data
(63) Continuation-in-part of application No. 14/142,647, filed on Dec. 27, 2013.
(60) Provisional application No. 61/746,717, filed on Dec. 28, 2012.

(51) Int. Cl. G06Q 30/02

(52) U.S. Cl. CPC G06Q 30/0246; G06Q 30/0244; G06Q 30/0273
USPC 705/14.43

(57) ABSTRACT

A system and method for rule-based or algorithm-based automated response optimization in a marketing environment is provided. The system and method increases email or website open, click through, and fulfillment rates for advertisers, including newsletter advertisers, national retailers, manufacturers, non-profits and the like (“Customers”). Individuals who receive emails from any of the Customers or access websites with Customer's advertisements will become a Member through a simple enrollment process. The system and method rewards Members for opening, clicking through and/or fulfilling advertisements disseminated through emails or websites with a proprietary currency and trading floor. The rewards may be exchanges on the trading floor for coupons, goods, services and actual cash.

### CROSS-REFERENCE TO RELATED APPLICATION

This application is a continuation-in-part of U.S. application Ser. No. 14/142,647, filed on Dec. 27, 2013, which claims the benefit of U.S. Provisional Patent Application No. 61/746,717, filed on Dec. 28, 2012. The entire contents of the entire chain of applications are herein incorporated by reference.

### FIELD OF THE INVENTION

The present invention relates generally to an incentivized marketing system and method, and more specifically to a marketing system and method that provide incentives through online advertising, such as email, website, online video, search engine, social media, display advertising, web enabled television, and other types of online or web enabled marketing.

### BACKGROUND OF THE INVENTION

Online advertising, also called Internet advertising, is a rapidly growing business. It uses the web to deliver promotional marketing materials to consumers. Examples of online advertising include email marketing, online video advertising, search engine marketing, social media marketing, display advertising (including web banner advertising), and mobile advertising, among others.

Online advertising in the form of email messaging, for example, is a powerful and cost-effective way to market products or services and build relationships with customers and prospects. It is no longer an “emerging” marketing channel, but has instead become a required tool for any successful marketing plan. The email advertising industry is growing at a compound annual growth rate of 20% and is projected to reach $18 billion in 2013. According to Price Waterhouse Coopers, the first quarter revenue growth for 2012 was $8.46 billion-$1.1 billion and 15% greater than the first quarter results for 2011 ($7.36 billion). The half year results were similarly robust, with 2012 logging $17.03 billion compared to $14.94 billion for the same period in 2011 (increases of $2.1 and 14%).

Email marketing can be accomplished at substantially lower costs than other marketing methods. Email reaches a wider audience in a shorter time period for far less money than needed to invest in a comparable direct marketing campaign. Email marketing is not “one-off” spot communication, but rather a sustained, evolving dialogue that builds and maintains customer relationships. A marketing email consists of the list of email addresses to which the mailing is to be sent and the content to be sent to those addresses. Content itself can contain text, pictures, multi-media data, HTML, scripts, and the like, as well as links that can be clicked on by the email recipient and that lead to Internet URLs that themselves contain information and/or items for sale.

Statistics can be automatically accumulated about the number of messages sent and what happens to them. These statistics are available in the form of reports generated by the computer-based mailing application. Reports contain information not only on how many emails were sent, but also on what happened to them (“responses” generated), i.e., how many were actually received, how many failed to be delivered, how many were opened and read by recipients, how many opt-out requests were made (requests to be removed from a mailing list), how many times links within the email were clicked on so that the recipient could view a website, how many email replies were generated, and generally how “successful” the email was.

Numerous other events can be tracked and used to gauge a successful email, such as the time spent at a clicked through website, signing on to a clicked through website, numbers of purchases made, and other similar events. Such events are typically referred to collectively as “response events” or just “responses.” A “conversion” or “conversion event” is a type of response event generally encompassing any specific action by a recipient that was the intended objective of the marketer, such as an online purchase of goods or services made by the email recipient as a result of the email. Other conversion events include other types of transactions that are completed online, such as, online registrations, filling out surveys, etc., and/or offline activities, such as creating brand awareness, store visits, etc. The use herein of the expression “conversion” or “conversion event” is intended to include all such responses. Marketers seek to generate as many response events as possible.

The fundamental email advertising industry metrics are comprised of:
1. The open rate (the “OR”) is the ratio between the number of registered opens to the number of emails sent.
2. Generally, if the opener leaves the page in 3 seconds or less the email is not counted as opened.
3. If the opener stays on the page for more than 10 seconds, it is also counted as read. Some email service providers, as well as some marketers, count only the number of emails actually delivered when calculating the open rate.

The click through rate (the “CTR”) is the ratio between the number of clicks after open to the number of emails opened. For example, if an email was opened by 100 subscribers and 30 of those subscribers clicked on a link, then the CTR would be 30%.

The conversion rate (fill) is the ratio between the number of conversions to the number of clicks. A conversion can be anything, such as a sale, request for more information, additional subscription, or whatever the subscriber is asked to do. For example, if, of those 30 subscribers that clicked on a link, 3 purchased something, then the conversion rate would be 10% (a few marketers divide the number converted by the original mailing which in this example would be 3%).

Click through and conversion rates are the most important indicators of email performance and drive the action from each e-correspondence. The average rates thru June 2011 are listed in the table below.

TABLE 1
Average Rages - June 2011

| | |
|---|---|
| Average Open Rate | 23.3% |
| Average Click Thru Rate | 5.9% |
| Average Delivery Rate | 96.0% |

Q1 Open Rate Increased:

| | |
|---|---|
| Qtr over Qtr | =5.6% |
| Year over Year | =4.2% |

Source: Epsilon Q1 2011 Email Trends & Benchmarks

Considerable time, energy, and brainpower are being focused on raising the above rates. E-advertising professionals recommend a myriad of strategies to improve these rates. The ideas include: scrubbing email lists, opting-in, double opting-in, subject line strategies, such as using all CAPS, or lists of words to avoid, what days of the week produce greater responses, what time of the day is best to send an email, and so on. All of these are strategies to entice the receiver to open an unrequested email. And when the results of all these strategies are reviewed, the increase in response rates seem hardly worth the effort. Any improvements are generally limited to mere fractions of a percent.

According to Exact Target's “Email X-Factor Study” (2010), people open unsolicited emails hoping to get something for free or at a discount. 67% want a discount or promotion, 55% want something for free. Only 14% want to interact with the brand:

TABLE 2
Email Opener Motivation

67% want look for discounts & promotions.
55% want a freebie.
14% want to interact with the brand.

Source: Exact Target “Email X-Factor Study” (2010)

Email marketing through newsletters, bulletins, advertorials, and other e-correspondence is growing at a pace that exceeds 20% per year for the last 5 years. The domestic market alone has e-correspondence made up of over 125,000 different newsletter or bulletin type pieces that each contain some form of marketing embedded within. According to PWC, the market has grown from $9.6 billion to $16.6 in just 5 years. This is an increase of 73%.

The email newsletter business has grown in the last 5 years from $1 billion in gross revenues to $2.6 billion. This increase is mainly due to advertiser's increasing appetite for Internet Advertising. The proliferation of email newsletters and other email “advertorial” advertising has created a need for the system and method of this invention. Marketers are desperate to increase open rates and advertisers are eager to pay more for higher open rates just as television and radio networks are always trying to increase ratings and advertisers, as always, are eager to pay for those higher ratings.

Retailers are seeking to increase online sales, increase the amount of the average sale, and also to increase traffic at brick and mortar locations. Manufacturers are seeking to increase their new customer base while retaining their loyal customer base. Non-profits want to increase donations. All are faced with the same dilemma—flooded with more and more unsolicited emails, people are simply ignoring most of it. 2011 open rates by industry break down as follows:

TABLE 3
Typical Open Rates (%)

| | | |
|---|---|---|
| | 100% | |
| | 90% | |
| | 80% | |
| | 70% | |
| | 60% | |
| | 50% | Manufacturing |
| Non profit | 40% | Religious |
| Travel | | Art |
| | | Government |
| Health | 30% | Education |
| Real estate | | Photography |
| Technology | 20% | Publishing & Media |
| Insurance | | Marketing |
| | | E-commerce |
| | 10% | |

There are certainly some broad trends in open rates. As company and list size goes up, the open rate tends to fall; possibly because smaller companies are more likely to have personal relationships with their list subscribers. Companies and organizations that are focusing on enthusiasts and supporters, like churches, sport teams and non-profits enjoy higher open rates. More specific niche topics also typically have higher open rates than emails on broader topics.

Thus, there is a need for an email marketing system and method that will significantly increase email open, click through, and fulfillment rates for its newsletter advertisers, national retailers, manufacturers, non-profits, and the like.

Similarly, online video advertising and online video content producers are both facing challenges to meet advertiser demand, sustain consistent and increasing viewership, and intelligently increase advertising content relevance for targeted audience segments. The three main constituents of online video advertising include the online video advertisers, online video advertising networks, and online video content producers. According to a June 2013 report from Accustream Research, digital pre-roll and in-stream advertisement inventory is projected to increase about 20% for the year, while the corresponding media spend is outpacing that growth at an expected increase of over 38% —clearly highlighting the issue that inventory are not keeping up with demand growth. Estimates range from 50% to as high as 94% of digital pre-roll ‘skippable’ advertisements are skipped immediately. Media spend against digital pre-roll alone will reach $3 billion in 2013. Emerging advertising platforms (mobile, social, video on demand) currently captures about 14% of the total video in-stream spend, and is expected to reach nearly 30% by 2016. As such, there is also a need for a marketing system and method to increase the ‘eyeball capacity and stickiness’ for advertisers and publishers in digital video by increasing consumer engagement, return on investment effectiveness and relevance of currently available advertisement and content inventory.

In addition, since online marketing is growing rapidly over a multitude of media platforms, there is further a need for a marketing system and method that provide incentives through a variety of platforms, including, but not limited to websites, search engines, social media, display advertising, web enabled television, and other types of online or web enabled marketing platforms.

### SUMMARY OF THE INVENTION

One object of the present invention is to provide an incentivized marketing system and method through online advertising, including, but not limited to email marketing, website marketing, online video advertising, search engine marketing, social media marketing, display advertising (including web banner advertising), and mobile advertising.

Another object of the present invention is to provide an incentivized marketing system and method focuses on email newsletters, news bulletins and other email “news” providers.

Another object of the present invention is to significantly increase email open, click through, and fulfillment rates for its newsletter advertisers, national retailers, manufacturers, non-profits, and the like (“Customers”). Any individual who receives an email from any Customer will become a Member through a simple enrollment process. The turn-key system and method of the present invention includes rewarding Members for opening, clicking through or fulfilling emails with a proprietary currency. This currency will have real value and can be traded through a proprietary trading floor for coupons, merchandise, cash, etc.

Another object of the present invention is to provide an incentivized marketing system and method focuses on online video advertising. The present invention offers online video viewers on any device or online medium the opportunity to earn proprietary currency as a result of viewing video advertisements. Proprietary currency may be earned at multiple events, including during a segment of online content on online video networks. The present invention may operate on a multi-device platform, including desktop, mobile, social and future mediums such as video on demand and interactive TV.

In one embodiment of the invention, a computerized method is provided for optimizing response to a marketing campaign, comprising: creating a marketing message, publishing the marketing message to a targeted recipient on a website, electronically tracking at least one selected response event occurring as the targeted recipient interacts with the marketing message, and providing an incentive to the targeted recipient for performing the selected response event.

In another embodiment of the invention, a system is provided for optimizing selected responses of a marketing campaign, comprising: electronic means for creating a marketing message, at least one server in communication with the electronic means for publishing the marketing message to a targeted recipient on a website, means for electronically tracking at least one selected response event occurring as the targeted recipient interacts with the marketing message, and means for transferring currency to the targeted recipient in exchange for performance of the selected response event.

In yet another embodiment of the invention, a system is provided for optimizing a marketing campaign, comprising: a database for electronically storing a plurality of marketing messages, a web server coupled to the database for publishing a marketing message selected from the plurality of marketing messages to targeted recipient on a website and for receiving electronic signals representative of at least one selected response event by the targeted recipient, and computer-based software electronically coupled to the web server for electronically tracking said at least one selected response event as it occurs and for automatically transferring currency into an account associated with the targeted recipient as compensation for the tracked selected response event.

In another embodiment of the invention, a computerized method is provided of optimizing response of a marketing campaign. The method comprising: creating a marketing message in the form of an email, sending the email to a predetermined number of targeted recipients, electronically tracking at least one selected response event occurring as the email is being sent to the targeted recipients, and providing an incentive to the recipients for performing the selected response event. The selected response event may be comprise deliverability rate, open rate, click through rate, conversion rate, purchase rate, reply rate, and unsubscribe rate.

In another embodiment of the invention, a system is provided for optimizing selected responses of an email marketing campaign. The system comprising: electronic means for creating a marketing message in the form of an email; at least one server in communication with the electronic means for sending the email to a predetermined number of targeted recipients; means for electronically tracking at least one selected response event occurring as the email is being sent to the targeted recipients; and means for transferring currency to the targeted recipients in exchange for their performance of the selected response event. The system may further comprise a trading platform that may enable the selling or exchanging of earned currency for goods or services.

In yet another embodiment of the invention, a system for optimizing an email marketing campaign is provided. The system comprising: a database for electronically storing a list of email addresses of targeted recipients of an email containing a marketing message, an email server coupled to the database for sending the email to targeted recipients and for receiving electronic signals representative of at least one selected response event by the targeted recipients; and computer-based software coupled to the email server for electronically measuring the at least one selected response event as they occur; the computer-based software including means for automatically transferring currency into accounts associated with the targeted recipients as compensation for the measured selected response event. The system may further comprise a trading platform that enables the selling or exchanging of earned currency for goods or services.

In yet another embodiment of the invention, a computerized method for providing a reward trading platform is provided. The method comprising: determining whether an email recipient performed at least one predetermined selected response event or determining whether a targeted recipient performed at least one predetermined selected response event as a result of an interaction with a marketing message published on a website. The method further comprises depositing currency into an account of the targeted recipient based on performance of the predetermined selected response event, receiving notification from the targeted recipient to exchange the currency for at least one good or service; and exchanging the currency for the at least one good or service.

In a further embodiment of the invention, a computerized method is provided for optimizing response to an online video marketing campaign, comprising: creating a marketing message, publishing the marketing message to a targeted recipient before, during, or after playing of an online video on a website, electronically tracking at least one selected response event occurring as the targeted recipient interacts with the marketing message, and providing an incentive to the targeted recipient for performing the selected response event.

Other objects, features, and characteristics of the invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

Further understanding of the invention can be obtained by reference to preferred embodiments set forth in the illustrations of the accompanying drawings. Although the illustrated embodiments are merely exemplary of systems for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the invention, reference is now made to the following drawings in which:

FIG. 1 is a schematic diagram illustrating a system for providing incentivized marketing according to a preferred embodiment of the invention;

FIG. 2 shows an exemplary flow diagram for the email marketing and incentive system and method according to an embodiment of the invention;

FIG. 3 shows an exemplary flow diagram wherein the email marketing and incentive system and method is controlled by a third party according to a preferred embodiment of the invention;

FIG. 4 shows an exemplary flow diagram for website marketing and incentive system and method according to a preferred embodiment of the invention;

FIG. 5A shows an exemplary flow diagram for online video marketing and incentive system and method according to a preferred embodiment of the invention; and

FIG. 5B shows an exemplary screen shot of a website displaying the online video marketing and incentive system according to a preferred embodiment of the invention.

### DETAILED DESCRIPTION OF THE INVENTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

The incentivized marketing system and method of the present invention will increase open, click through, and fill rates to Customers by providing advertisements comprising incentives in the form of proprietary currency to Members. For the purposes of this disclosure, the term “Customer” is used hereinafter to identify the party who wishes to add the incentive program to its marketing campaign. The Customer may be a newsletter advertiser, retailer, manufacturer, wholesaler, distributor, supplier, non-profit, or the like. For the purposes of this disclosure, the term “Member” is used hereinafter to identify the “target” of the incentive program; that is, the person to whom the advertisement is directed and thereby from whom a desired action is solicited, such as a purchase, a subscription, a response, and so on.

The incentivized advertisements or “ads” of the present invention may be disseminated to Members via any known or later discovered online advertising platforms, including, but not limited to, through emails, websites (e.g., Customer's or third-party publisher's web pages), search engines, social media websites, video-sharing websites, mobile websites, video on demand (VOD), through televisions directly or through set-top boxes, through any web enabled device, or the like. The incentivized advertisement may be provided as display advertisements (using text, pictures, logos, animations, videos, photographs, or other graphics, multi-media data, HTML, scripts, and the like), web banners, pop-ups, pop-unders, video overlays, floating ads, expanding ads, as online video ads (as pre-roll, mid-roll and post-roll ads), or the like. When delivered through the television or set-top box, the incentivized advertisements may be displayed as part of the TV guide, the program information banner, a dedicated advertisement channel, or the like. In addition, the advertisement may be delivered to the Member's mobile device as static or rich media display ad, Short Message Service (SMS) ad, Multimedia Messaging Service (MMS) ad, mobile search ad, advertising within mobile website, ad within mobile applications or games, or the like.

The proprietary currency of the present invention may be in the form of units, or loyalty points, which will have real value and can be traded through a proprietary trading floor for coupons, merchandise, cash, etc. In order to receive currency, the Member must take an action with respect to an advertisement directed towards the Member (i.e., “Response Event”). Performing each Response Event will earn the Member additional currency points. Response Events may be any trackable interaction by the Member with the advertisement. Response Event may include, but are not limited to, viewing the advertisement, viewing additional advertisements, a click-through (i.e., the process of clicking on the advertisement and going to the advertiser's web site), interacting with the Customer's or third-party Manager's website, performing a search on the Customer's website, making a purchase on the Customer's website, forwarding the advertisement or a link to the Customer's website to another user, posting the advertisement or a link to the Customer's website to a social media website, registering with the Customer's or third-party Manager's website, becoming a Member of the incentivized program to receive additional currency, subscribing to the Customer's or third-party Manager's social media webpage, getting a friend to register with the Customer's website, signing up for a newsletter, providing feedback, taking a survey, or the like. When the incentivized advertisement is disseminated through an email, Response Events may also include opening the email, forwarding the email to other users, replying to the email, or the like. For example, a Member receiving an advertisement through an email must open the email, scroll down to a certain identified button, and click to receive proprietary currency. In order to receive additional click through currency, the Member must perform additional Response Events, for example, click on an advertisement and then find and click on the identified button in the advertisement, and/or click on the identified button and make a purchase. Examples of Response Events when an incentivized advertisement is disseminated through a video-sharing website may further include watching a portion of or the entire advertisement, watching the selected video associated with the advertisement, skipping or not skipping the advertisement, watching additional advertisements or videos, clicking on/through the advertisement, sharing the advertisement or the selected video with other users, via email or social media websites, liking the advertisement or the selected video, subscribing to the Customer's, third-party Manager's, or selected video provider's channel, or the like.

The incentivized marketing system can be run by the Customer (e.g., newsletter advertiser, national retailer, manufacturer, non-profits, and the like) directly using a marketing Manager, or be controlled by a third party Manager. For the purposes of this disclosure, the term “Manager” is used hereinafter to identify the party that provides the incentive program of the present invention, which could be the Customer of a third-party Manager that provides the marketing platform to the Customer. When Customers control the backend of their module, they can add, alter, or delete their offers and deals on a real time basis.

The present invention also provides a trading platform (Trading Floor) that allows Members to sell or exchange their earned currency for goods and services. Members will have the opportunity to buy, sell or trade their currency with other Members or directly with retail, manufacturing or non-profit Customers on the Trading Floor. Each Member and Customer will be assigned a seat on the Trading Floor from which each will be able to see all the activity on the floor. The Trading Floor may be accessed through a link from a Customer or third party website and may be a standalone component. Its design may resemble a Wall Street trading floor. The Trading Floor will have many different facets. Each Member may have the opportunity to buy, trade, or sell currency. The sell price may be established by the Members, retailers, manufacturers and charities on a bid/ask basis. Members may be allowed to apply to become a market maker. There will be specific qualifications to become a market maker (e.g., financial ability, account balances, history on the floor). Market Makers will be seated in a special area of the floor and will be able to accept bids and put up an ask for quantities of currency. Retailers may offer additional currency for certain purchases and additional savings. Manufacturers may offer currency for redeeming coupons and trying and reviewing new products. Charities may accept currency as donations and will offer currency for additional cash donations. Newsletter owners may offer currency for sign-ups.

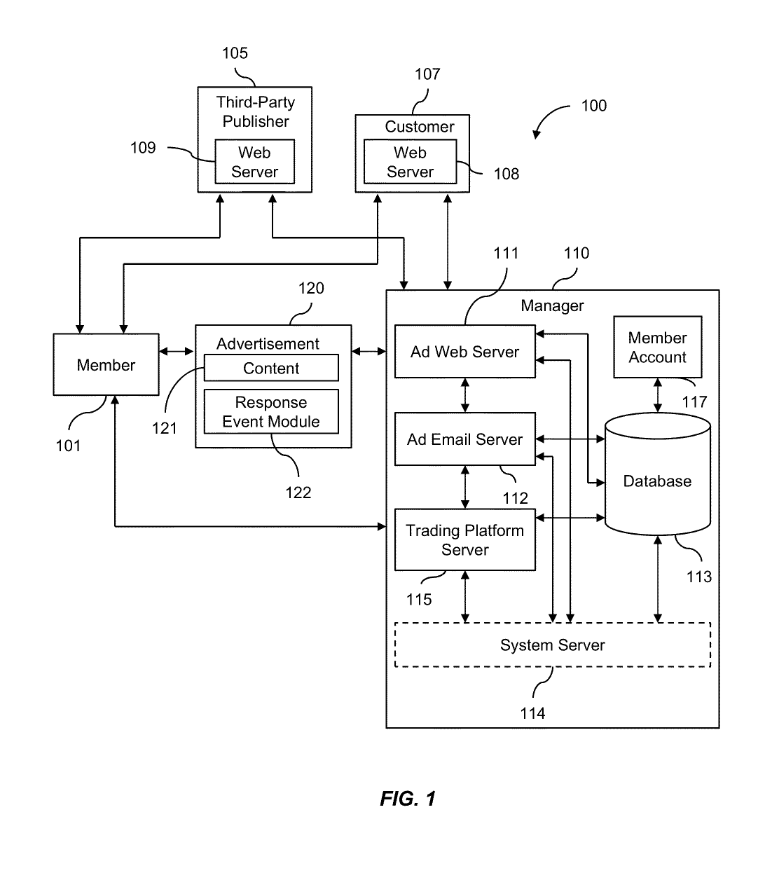

Referring to FIG. 1, there is shown a schematic diagram illustrating system 100 for providing incentivized marketing according to a preferred embodiment of the invention. System 100 comprises member communication device 101, customer computer 107, manager computer 110, and may also comprise a third-party publisher computer 105 for exchange of information required for providing an advertisement 120 to member communication device 101 over a communication network according to a preferred embodiment of the invention. The information between system components may be transmitted across any communication network known in the art, or later discovered, including but not limited to wired, wireless, Internet, intranet, Ethernet, WAN (wide area network), LAN (local area network), virtual private network, Wi-Fi, WLAN (wireless local area network), cellular or mobile, GSM (Global System for Mobile Communications), CDMA (Code division multiple access), ISDN (Integrated Services Digital Network), Bluetooth, CATV (cable television), satellite, or the like. The communication networks may include both wired and wireless connections, including optical links. It should also be appreciated that multiple communication networks may be used to transmit information between different system components, and that some or all of these communication networks may be private, dedicated networks in addition to the use of public networks such as the Internet.

Customer computer 107 may be operated by or associated with a Customer who desires to disseminate incentivized advertisements 120 to Members 101. The Customer may be an advertiser, newsletter advertiser, retailer, manufacturer, wholesaler, distributor, supplier, non-profits, or the like. Customer computer 107 may comprise a web server 108 for publishing the Customer's website and/or for exchanging information with Members 101 and Manager 110.

Manager computer 110 may be operated by either the Customer 107 or a third-party Manager to provide the interface between the Customer 107 and the Member 101. The manager computer 110 may comprise an ad web server 111, an ad email server 112, or other appropriate servers to electronically disseminate advertisements to Members associated with communication devices. The manager computer 110 may further comprise a trading platform server 115 for providing the Trading Floor to Members 101. Web server 111, email server 112, and trading platform server 115 may be incorporated into a conventional standalone server, although in other embodiments, the functions of the servers may be distributed across multiple computing systems and architectures. The system 100 may further include a separate system server 114 as an interface between the web server 111, email server 112, and trading platform server 115 for processing information. The web server 111, email server 112, and trading platform server 115 are network servers utilizing processing modules for processing information received to create and disseminate the incentivized advertisements. The servers of the present invention, including web server 111, email server 112, trading platform server 115, system server 114, customer web server 108, third-party publisher web server 109, and/or other system servers may include at least one controller or processing module (CPU or processor), at least one communications module port or hub, at least one random access memory module and one or more data storage modules. All of these latter elements are in communication with at least one processing module to facilitate the operation of the Manager 110 of the present invention.

The manager computer 110 may further comprise a database 113. Web server 111, email server 112, trading platform server 115, and system server 114 interface with the database 113 to provide secure storage and access to all information associated with its Members, such as Member 101, and Customers, such as Customer 107. The database 113 may be co-located with the web server 111, email server 112, trading platform server 115, and system server 114, or it may represent distributed data systems located remotely in various different systems and locations. The database 113 may store information associated with the Member 101, Customer 107, and/or third-party publisher 105, including Member Accounts (e.g., personal information, profile, and earned currency units), Customer Accounts (entity information, advertisement campaign information, advertisement content, lists of targeted recipients of the advertisement content, and available funds of currency units for redemption), as well as links and other data related to Third-Party Publishers websites on which the manager 110 disseminates Customer's advertisements. Web server 111, email server 112, trading platform server 115, system server 114, and database 113 may include any one of numerous forms of storage devices and storage media, such as solid-state memory (RAM, ROM, PROM, and the like), magnetic memory, such as disc drives, tape storage, and the like, and/or optical memory, such as DVD.

Customer computer 107 may provide the advertisement content to a manager computer 110 for dissemination to member communication devices 101. The advertisement content provided by the Customers is preferably stored in the database 113. The database 113 may store content of a plurality of advertisements for a plurality of third-party Manager's Customers. The Manager 110 generates and provides the incentivized advertisement 120, including the advertisement content 121, to the member communication device 101 through a web server 111, an email server 112, or any other server adapted to electronically transmit an advertisement to a communication device. The advertisement 120 may be provided to the Member via any known or later discovered electronic advertising platforms. The advertisement 120 may be provided via the email server 112 through an email or it may be displayed to the Member on a webpage via the Manager's web server 111. The advertisement 120 may be displayed on the Customer's webpage published through the Customer's web server 108, or it may be published by a third-party publisher 105 thorough the third-party's web server 109 on a third-party website, a search engine, a social media webpage, a video-sharing website, video on demand, or the like. The advertisement 120 may be provided in any form, including as a display advertisement (using text, logos, animations, videos, photographs, or other graphics), web banner, pop-ups, pop-unders, video overlay, floating ad, expanding ad, as online video advertising (as pre-roll, mid-roll and post-roll ads), or the like. In addition, the advertisement 120 may be delivered to the Member's mobile device as static or rich media display ad, Short Message Service (SMS) ad, Multimedia Messaging Service (MMS) ad, mobile search ad, advertising within mobile website, ad within mobile applications or games, or the like.

A Member may utilize the member communication device 101 to access the advertisement 120 provided by the Manager 110 through the web server 111 or email server 112. Member communication device 101 may comprise any communication device known in the art or later discovered capable of displaying electronic advertisements. For example, member communication device 101 may comprise a computer, personal computer, desktop computer, laptop computer, mobile device, handheld device, cellular telephone, smartphone, web-enabled cellular telephone, personal digital assistant, tablet, televisions or set top boxes supporting video on demand (VOD), interactive televisions, smart television, internet television, or the like.

In a preferred embodiment, the incentivized advertisement 120 comprises content—i.e., the actual advertisement that is displayed to the Member on the member communication device 101. In addition, the advertisement 120 is associated with at least one response event module 122—i.e., an electronically trackable event corresponding to the Member's interaction with the advertisement 120. Examples of response events include clicking through the website, signing on to a clicked through website, making a purchase, registering with the clicked through website, completing a survey, or the like. The Manager 110 electronically tracks the response event selected and performed by the Member via a tracking module or software executed on the web server 111, email server 112, or on the Member communication device 101. Electronic tracking of the Member communication device 101 may be accomplished via any electronic tracking technology known in the art, including, but not limited to, “cookies” (i.e., small data files stored by a web browser on the Member's communication device 101), web bugs, web beacons, tracking bugs, tags, or webpage tags (i.e., objects embedded in a web page or email used for tracking user activities), or other now known or later discovered electronic tracking technologies.

In response to the Member performing the selected response event, the web server 111 or email server 112 adds or transfers currency units to the Member Account 117. To effectuate the transfer, the Member registers with the Manager and creates a Member Account 117 using the communication device 101. The Member Account 117 is preferably stored in the database 113 associated with the Member. Manager 110 maintains all information associated with its Member Accounts 117 in database 113 for each respective Member, with web server 111, or other system server, processing transactions and/or calculations for providing access to the information through database 113. The Member Account 117 keeps track of Member currency units and may include a Member profile, with personal information. The Member Account 117 can be accessed by the Member using the communication device 101 to add, edit, or use the information associated with the Member Account 117. The Member may also access the Member Account 117 via the member communication device 101 to manage Member's collected currency.

The Member may use the communication device 101 to access the Trading Floor provided by the trading platform server 115 to buy, sell, or trade their earned currency for goods and services. For example, the Member may trade the earned currency units for coupons, merchandise, or cash. The Member can buy, sell or trade the currency units with other Members or directly with the Customer on the Trading Floor. For example, the Member may redeem Customer's merchandise for particular amount of currency units. Each Member and Customer will be assigned a “seat” on the Trading Floor from which each will be able to see all the activity on the floor.

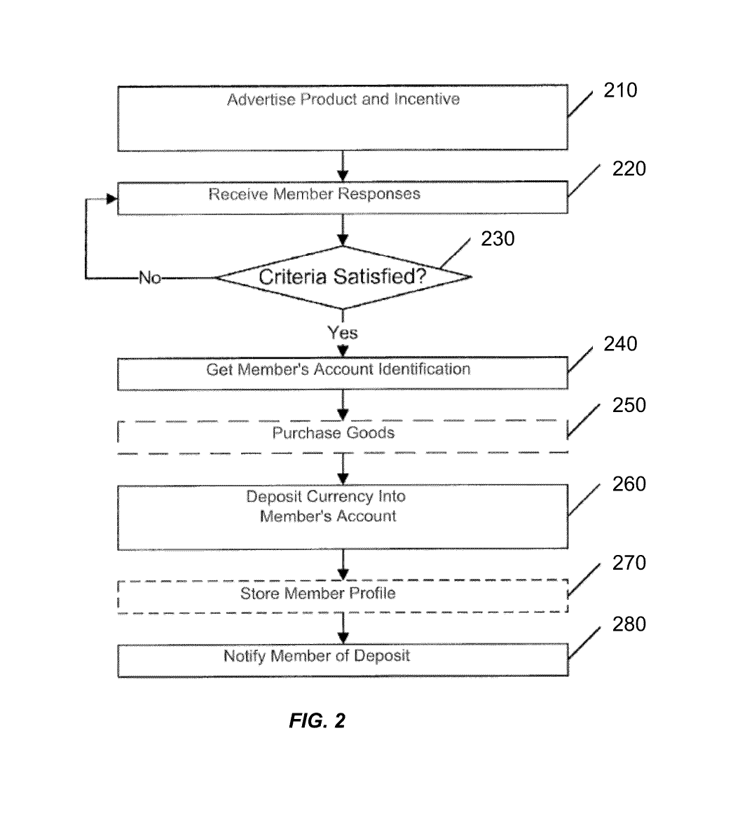

Turning now to FIG. 2, an exemplary flow diagram for the email marketing and incentive system is provided. The email marketing system of the present invention may comprise a database 113, an email server 112, and a computer-based software coupled to the email server 112 (shown in FIG. 1). The database 113 may electronically store a list of email addresses of targeted recipients or Members of an email containing a marketing message. The email server 112 may be coupled to the database 113 for sending the email to the targeted recipients or Members and for receiving electronic signals representative of at least one selected response event by the targeted recipients or Members. The computer-based software may be coupled to the email server 112 for electronically measuring or tracking the at least one selected response event as it occurs. The computer-based software may automatically transfer currency units into accounts associated with the targeted recipients, such as Member Account 117, as compensation for the measured selected response event.

As shown in FIG. 2, at 210, the offer for the actual goods and/or services and the incentive of obtaining currency is advertised to the Member in an email. At 220, the Member's response events are received and processed. Such response events may include typical web-page interactions, click throughs, searches, and so on, all of which can lead to an award of currency. At some point, the Member may, for example, make a purchase at 250, and, at 230, the system will proceed to satisfy the offer.

To initiate the redemption process, the system queries the Member to obtain the information necessary to effect the transfer of currency into the Member's account, at 240. The particular procedure for accessing the Member's account and providing a deposit will be dependent upon the particular environment associated with the account. Most environments allow users to “gift” credits from one user to another, and in a preferred embodiment, the provider of the incentive establishes a relationship with a third party provider of the environment to facilitate such transfers. At 260, the system deposits currency into Member's Account.

In a preferred embodiment of this invention, the system also requests permission to obtain the user's email address and to access the user's profile information. The email address is nominally requested for sending a confirmation email regarding the deposit of currency, but also serves to allow the retailer to send targeted emails to the Member with other offers and incentives and to validate the email inputted to ensure quality leads and information about the Member. The Member's profile information may be stored at 270 in the Member Account 117 on the database 113 and subsequently used to determine the Member's preferences and demographics, and to facilitate selective targeting and personalization. The profile information may also be used to identify goods and/or services that the Member may have an interest in, based on gender, age, expressed interests, and so on.

At 280, the Member is notified of the currency deposit. In preferred embodiments, the Member may be provided with the opportunity to publish an opinion of the transaction, rate the advertisement or product, etc. The Member's agreement to publish an opinion may also result in the deposit of additional currency into the Member's account.

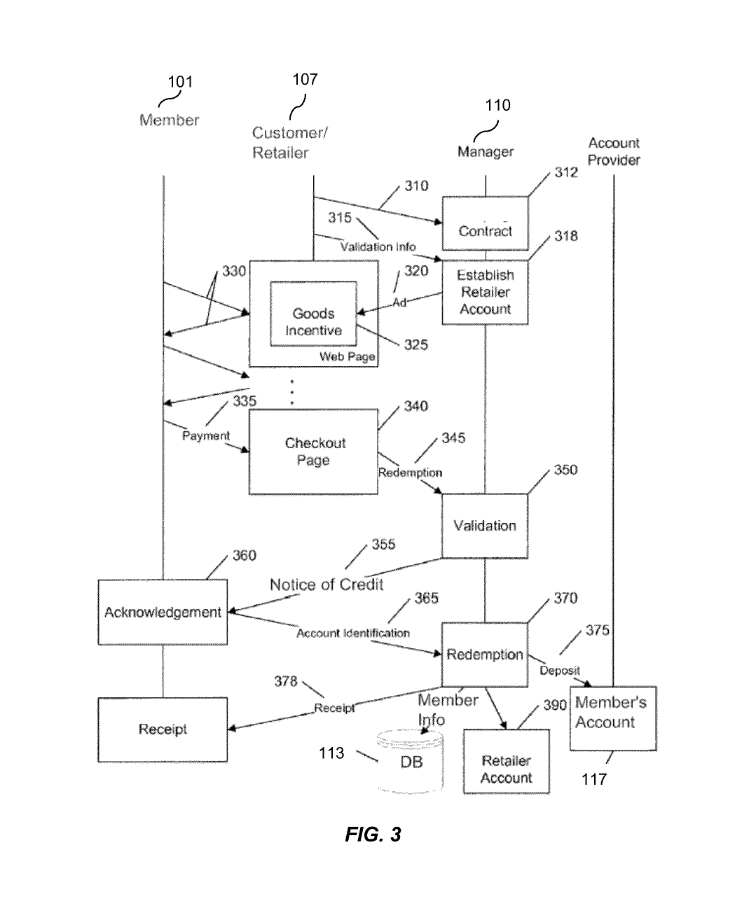

In a preferred embodiment of this invention, a third party Manager provides the interface between the Customer (e.g., retailer) and the Member. Preferably, the third party Manager warrants the transfer of currency to the Customer and the exchange of goods and services to the Member. FIG. 3 illustrates an exemplary flow diagram for an email marketing and incentive system using the third party Manager.

By way of example, a retailer (i.e., Customer) that desires to add an incentive program to an advertising program for goods contacts 310 the third party Manager and enters into a contract 312 with the Manager. The contract may take any number of forms, including a fixed price contract, but in general, a commission-based contract is particularly well suited for marketing campaigns. Generally, the campaign Manager will establish an account 318 for the retailer, with a fixed ceiling amount that sets an upper limit to the cost of providing the currency incentive. Associated with this account is confidential information 315 associated with the retailer that serves to validate transactions related to the retailer's account, as detailed further below. Depending upon the particular contract, the retailer may be required to provide a down payment of actual funds to support the campaign, and/or to replenish the actual funds as the balance in the account is drawn down by the purchase of the virtual goods that are transferred to the clients.

In one embodiment of this invention, the third party Manager 110 provides 320 the advertisement 325 for incentive. The Member 101 interacts 330 with the retailer's web site, and, in this example, eventually executes a purchase for an actual object and remits payment 335 while interacting with the checkout page 340. Upon completion of the purchase, the retailer 107 notifies 345 the Manager 110 that the purchase has been completed, and instructs the Manager 110 to transfer currency to the benefit of the Member 101. Upon receipt of the parameters in the redemption message 345 from the retailer 107, the Manager 110 validates that the redemption message is a proper and authorized redemption request, at 350.

To validate that the redemption message was created by the particular vendor identified in the redemption message, the Manager 110 decrypts the encrypted element using the decryption process corresponding to the encrypting process used by the retailer. If the communicated token was a proper encryption of the unique identifier using the retailer's key, the result of this operation on the token at the third party Manager 110 site will be the unique identifier. If the determined result does not match the communicated unique identifier, the redemption is not executed and the process is terminated with an “invalid redemption request” error message.

If the determined result matches the unique identifier, the Manager 110 verifies that this redemption request is not a duplicate request by checking the retailer's account for this unique identifier. As detailed below, when a redemption request is granted, the Manager 110 records the redemption in the retailer's account, including the unique identifier. If the current unique identifier is already entered in the retailer's account, the redemption is not executed and the process is terminated with an “already redeemed” error message.

After validating that the redemption request is authorized by the retailer 107, and not a repeat of a previously granted redemption request, the Manager 110 notifies 355 the Member 101 that the redemption process is underway. The Member 101 acknowledges the transaction by providing the necessary information 365 for accessing the Member's Account 117. Other environments may provide different protocols and Application Program Interfaces (APIs) for accessing a Member's account to make currency deposits.

Upon receipt of the identification of the Member's account, the third party Manager 110 deposits 375 the offered currency into the Member's account 117, notifies 378 the Member 101 of the deposit, and records 390 this deposit in the retailer's account 390.

The recordation 390 of the deposit in the retailer's account includes the details associated with the redemption, such as the unique identifier of the redemption, and also effects a debit to the retailer's account, reducing the amount available to fund subsequent redemptions. If this redemption causes the cost of the campaign to reach (or approach) the aforementioned ceiling, the retailer 107 is notified, and offered the opportunity to increase the ceiling to continue the incentive program.

As noted above, in addition to gaining access to the Member's account to deposit the currency, the Manager 110 also accesses the information that the Member 101 has allowed the manager to access, such as the client's basic information (name, gender, age, etc.) and profile information (likes and dislikes, favorite activities, etc.). In a preferred embodiment of this invention, the third party Manager 110 maintains a client database 113 for storing this information for each client. In this manner, the Manager 110 may develop incentive campaigns that are specifically targeted to particular clients, or groups of clients.

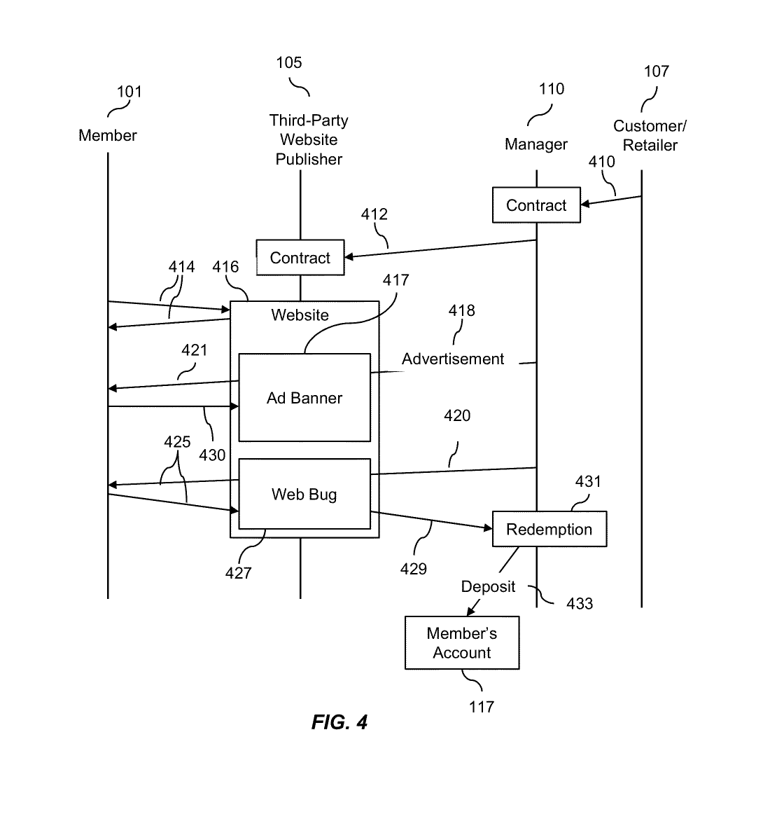

FIG. 4 illustrates an exemplary flow diagram of an incentivized website marketing system and method. The website marketing and incentive system and method of the present invention displays incentivized advertisement on the Customer's website or, as shown in FIG. 4 on a third-party publisher's website. The website marketing system of the present invention may comprise a database 113, a web server 111, and a computer-based software coupled to the web server 111 (shown in FIG. 1). The database 113 electronically stores a plurality of marketing messages, or advertisements. The web server 111 is coupled to the database 113 for publishing a marketing message or advertisement selected from the plurality of marketing messages to a targeted recipient on a website, for example, a third-party publisher's website provided by a third-party publisher web server 109. The computer-based software is electronically coupled to the web server 111 for electronically tracking at least one selected response event as it occurs and for automatically transferring currency into an account associated with the targeted recipient as compensation for the tracked selected response event.

As shown in FIG. 4, a Customer 107 that desires to add an incentive marketing program contacts and contracts 410 with a third party Manager 110. The third party Manager 110 in turn contracts 412 with a third-party publisher 105 to include the Customer's advertisement on a third-party publisher's website 416. A Member 101 visits and interacts with the third-party publisher's website at 414. The third party publisher's website 416 includes an advertisement banner 417, or any other form of advertisement displaying technology to display Customer's advertisement. The advertisement banner 417 receives the advertisement content 418 from the Manager 110 and displays 421 the advertisement 418 to the Member 101. The Manager 101 also embeds 420 a web bug 427 on the third party publisher's website 416 to track the activity of the Member 101. The advertisement content 418 may include text inviting the Member to earn currency units by clicking on the advertisement banner 417 to visit the Customer's website (i.e., performing the response event). The web bug 427 tracks 425 Member's interaction with the advertisement banner 417 and communicates it to the Manager 110. Specifically, upon the Member's clicking 430 on the advertisement banner 417 to visit the Customer's website, the web bug 427 communicates 429 the response event to the Manager 110. In response, the Manager 110 determines 431 whether a response event has been satisfied and if so deposits 433 earned currency units into Member's Account 117.

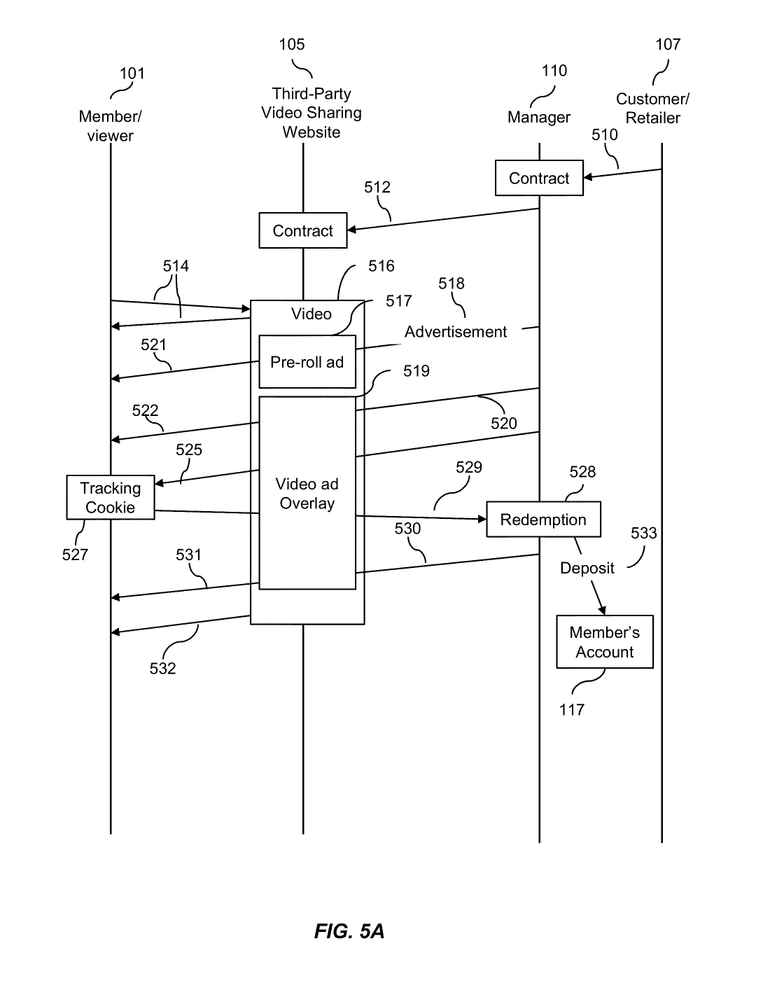

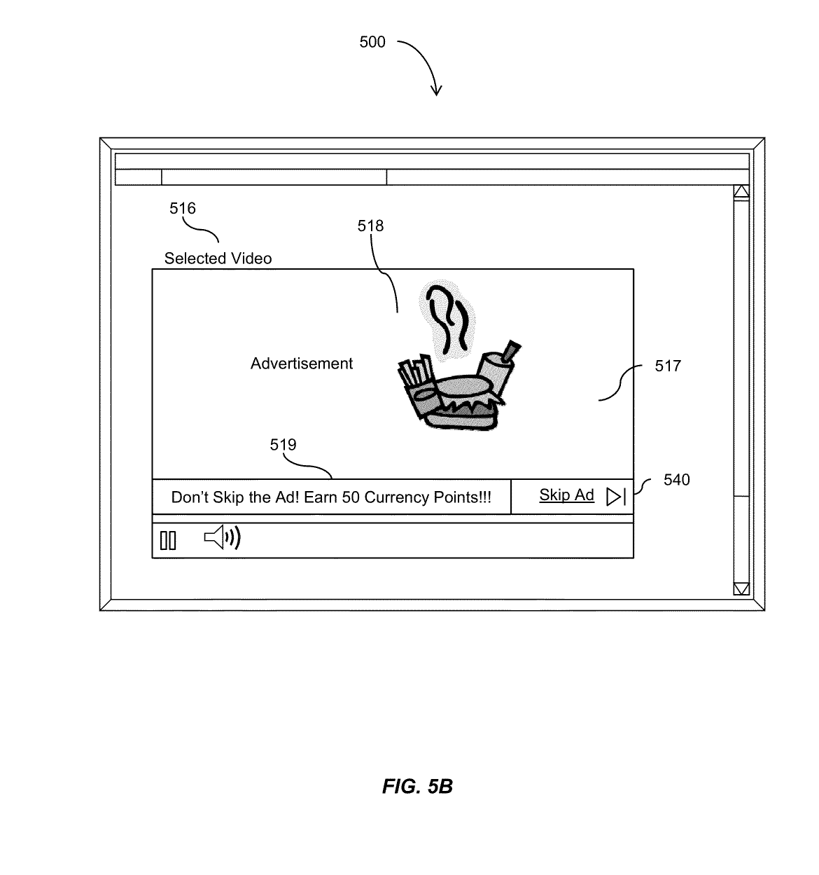

FIG. 5A illustrates an exemplary flow diagram of an incentivized online video marketing system and method and FIG. 5B shows an exemplary screen shot of a website 500 displaying the online video marketing and incentive system. The online video marketing and incentive system and method of the present invention offers online video viewers on any device or online medium the opportunity to earn currency during a segment of online video content on an online video networks, such as video-sharing websites. The incentivized advertisements may be displayed as pre-roll, mid-roll, or post-roll ads.

A Customer 107 that desires to add an incentive program contacts and contracts 510 with a third party Manager 110. The third party Manager 110 in turn contracts 512 with a third-party publisher 105, such as a video-sharing website, to include Customer's advertisement as a digital pre-roll ad unit on the third-party video sharing website. An online viewer (Member) 101 visits the third party video sharing website 500 (FIG. 5B) and selects a video 516 to watch 514. The video 516 is supported by a pre-roll ad unit 517 and a video ad overlay or “bug” 519. The pre-roll ad unit 517 begins to play 521 the advertisement 518 provided by the Manager 110 for typically 15 or 30 seconds, offering the viewer 101 a chance to skip the advertisement 518 after 5 seconds by clicking a “Skip Ad” option 540 (FIG. 5B). The video ad overlay or “bug” 519 receives information 520 from the Manager 110 to notify 522 the viewer 101 that this advertisement is supported by the incentivized online video marketing system of the present invention and offering the viewer 101 a response event not to choose the “Skip Ad” option and watch the entire or a portion of the advertisement 518 to earn currency units. A video overlay is an advertisement that appears in the bottom 20% of the video window. Similarly, a “bug” is a persistent, graphical element that appears in the video environment. Clicking the video overlay or “bug” generally initiates a video ad spot or takes the user to a website. The video overlay or “bug” 519 will also notify 522 the viewer 101 how many total currency units will be available by viewing the entire advertisement 518.

The Manager 110 will then track the response event using a tracking cookie 527 on viewer's communication device 101 to track the activity of the viewer. Initially, the Manager 110 will check for the presence of the tracking cookie 527. If no tracking cookie 527 is present, the Manager 110 will present 525 the viewer 101 the option of downloading the cookie 527 to the viewer's communication device 101. After the viewer 101 watches a portion of or the entire advertisement 518 (i.e., performs the response event), the tracking cookie 527 will send the Manager a redemption message 529 indicating to the Manager that the response event has been performed. The Manager 110 will determine 528 whether the redemption event has been satisfied and if so deposit 533 earned currency units into Member's Account 117. Then, the video 516 initially selected by the viewer 101 will be displayed 532 to the viewer, and the video ad overlay 519 will be updated 530 by the Manager 110 to notify 531 the viewer 101 how many currency units the viewer 101 has earned. The video ad overlay 519 may also display to the viewer 101 subsequent post-video offers, such as channel subscriptions, offer to subscribe to the Customer's channel, viewing other advertisements or videos, or offer to share the video 516 or the advertisement 518 with other users. If the viewer 101 is not a Member, the video ad overlay 519 may also display a registration link, which may be clicked to open a registration form in another window. If the third-party video sharing website 105 is also a client of the Manager 110, then the video ad overlay 519 may offer the viewer 101 additional currency to watch the entire video 516 initially selected by the viewer 101. After the video 516 is complete, the video ad overlay 519 may display the total number of currency units earned. The currency units of the present invention can be designed to be incremental in value for each step throughout the viewing of the video 516 and advertisement 518. Alternatively, the currency units may be provided at flat value for only choosing individual actions or events, such as skipping the ad but watching the video.

As part of the campaign, the incentivized marketing system and method of the present invention may disseminate advertisement non-electronically. For example, the incentivized advertisement of the present invention may be displayed on printed matter, including paper, magazines, books, business cards, billboards, clothing, and the like. The incentivized advertisement may invite the Member to go to a website to perform the response event. The website in turn will track the activity of the Member and redeem currency units to the Member's account as was previously described.

In another embodiment, the printed advertisement may include a barcode and the Member communication device 101 may include a scanning device adapted to scan the barcode and software adapted to read the barcode and communicate with the Manager 110. The scanning device may comprise any barcode reader known in the art, including an optical scanner or a camera connected to or integrated with the Member communication device 101. The barcode may have information for directing the Member communication device 101 to the Customer's website and information for directing the communication device 101 to communicate to the Manager 110. The advertisement may invite the Member to scan the barcode with the communication device 101 to visit the Customer's website in exchange for earning currency units. Upon scanning the barcode, the communication device 101 will direct the Member to the Customer's website and communicate the response event to the Manager 110, which upon receipt of the response event will deposit currency into Member's Account.

While the above description contains many specific details, these should not be construed as limitations on the scope of the invention, but rather as an exemplification of preferred embodiments thereof. Other variations are possible. Accordingly, the scope of the invention should be determined not by the preferred embodiment illustrated, but by the appended claims and their legal equivalents, as put forth hereinafter. Further, it will be apparent to those of skill in the art that numerous changes may be made in such details without departing from the spirit and the principles of the invention. It should be appreciated that the invention is capable of being embodied in other forms without departing from its essential characteristics.

What is claimed is:

1. A computerized method of optimizing response to a marketing campaign comprising:
creating a marketing message;
publishing the marketing message to a targeted recipient on a website;
electronically tracking at least one selected response event occurring as said targeted recipient interacts with said marketing message; and
providing an incentive to said targeted recipient for performing said selected response event.

2. The method of claim 1, wherein said selected response event is selected from the group consisting of: deliverability rate; open rate; click through rate; conversion rate; purchase rate; reply rate; and unsubscribe rate.

3. The method of claim 1, wherein said selected response event is selected from the group consisting of viewing the marketing message, viewing additional marketing messages, clicking on a link associated with the marketing message, interacting with a website associated with the marketing message, performing a search on a website associated with the marketing message, making a purchase on a website associated with the marketing message, forwarding the marketing message to another user, forwarding a link to a website associated with the marketing message to another user, posting the marketing message to a social media website, registering with a website associated with the marketing message, signing up for a newsletter, providing feedback, and taking a survey.

4. A system for optimizing selected responses to a marketing campaign comprising:
electronic means for creating a marketing message;
at least one server in communication with said electronic means for publishing said marketing message to a targeted recipient on a website;
means for electronically tracking at least one selected response event occurring as said targeted recipient interacts with said marketing message; and
means for transferring currency to said targeted recipient in exchange for performance of said selected response event.

5. The system according to claim 4, wherein said system further comprises a trading platform.

6. The system according to claim 5, wherein said trading platform enables the selling or exchanging of earned currency for goods or services.

7. A system for optimizing a marketing campaign comprising:
a database for electronically storing a plurality of marketing messages;
a web server coupled to said database for publishing a marketing message selected from the plurality of marketing messages to a targeted recipient on a website and for receiving electronic signals representative of at least one selected response event by said targeted recipient; and
computer-based software electronically coupled to said web server for electronically tracking said at least one selected response event as it occurs and for automatically transferring currency into an account associated with said targeted recipient as compensation for said tracked selected response event.

8. The system according to claim 7, wherein said computer-based software is executed on said web server.

9. The system according to claim 7, wherein said computer-based software is executed on a communication device of or associated with said targeted recipient.

10. The system according to claim 7, wherein said computer-based software comprises a cookie, a web bug, a web beacon, a tracking bug, a tab, a webpage tag, or any combination thereof.

11. The system according to claim 7, wherein said system further comprises a trading platform.

12. The system according to claim 11, wherein said trading platform enables buying, selling, or exchanging of earned currency for goods or services.

13. A computerized method for providing a reward trading platform, comprising:
determining whether a targeted recipient performed at least one predetermined selected response event as a result of an interaction with a marketing message published on a website;
depositing currency into an account of said targeted recipient based on performance of said predetermined selected response event;
receiving notification from said targeted recipient to exchange said currency for at least one good or service; and
exchanging said currency for said at least one good or service.

14. A computerized method of optimizing response to an online video marketing campaign comprising:
creating a marketing message;
publishing the marketing message to a targeted recipient before, during, or after playing an online video on a website;
electronically tracking at least one selected response event occurring as said targeted recipient interacts with said marketing message; and
providing an incentive to said targeted recipient for performing said selected response event.

15. The method of claim 14, wherein the response event is selected from the group consisting of playing a portion of the marketing message, playing the entire marketing message, playing a portion of the online video, playing the entire online video, skipping the marketing message, not skipping the marketing message, playing additional marketing messages, playing additional online videos, clicking on a link within the marketing message, sharing the marketing message with other users, and subscribing to a channel.

16. The method of claim 14 further comprising: displaying to said targeted recipient the provided incentive earned for performing said selected response event during or after playing of the online video on the website.
